(19) United States
(12) Patent Application Publication
(10) Pub. No.: US 2025/0180853 A1
(43) Pub. Date: Jun. 5, 2025

(54) LENS APPARATUS AND IMAGING SYSTEM

(71) Applicant: CANON KABUSHIKI KAISHA, Tokyo (JP)

(72) Inventors: TORU ISHIMASA, Kanagawa (JP); TOSHIHIRO OGAWA, Tokyo (JP); YOSHIKAZU WATANABE, Chiba (JP)

(21) Appl. No.: 18/920,090

(22) Filed: Oct. 18, 2024

(30) Foreign Application Priority Data
Dec. 4, 2023 (JP) 2023-204314

(51) Int. Cl. G02B 7/02

(52) U.S. Cl. CPC G02B 7/021

(57) ABSTRACT

In a lens apparatus, a cam barrel has a first cam groove for moving a first unit in an optical axis direction and a second cam groove for moving a second unit in the optical axis direction. A guide barrel has a first guide groove for restricting the first unit from rotating around an optical axis and a second guide groove for restricting the second unit from rotating around the optical axis. The second unit has a base unit and a holder unit disposed closer to the first unit than the base unit. As the lens apparatus transitions from an imaging state to a non-imaging state, the first unit moves closer to the second unit, and the second unit moves closer to the first unit, so that the holder unit and the first unit contact with each other.

### BACKGROUND

### Technical Field

The present disclosure relates to a lens apparatus and an imaging system.

### Description of Related Art

Japanese Patent Laid-Open No. 2006-215421 discloses a lens barrel having a retractable (or collapsible) mechanism in which a distance between first and second units is wide in an imageable state, but a distance between the first and second units is narrowed in a retracted state for restricting imaging, thereby reducing the overall length in the optical axis direction.

The lens barrel disclosed in Japanese Patent Laid-Open No. 2006-215421 needs a sufficient distance between the first and second units for retraction from an imaging end (wide-angle or telephoto end), and thus the overall lens length at the wide-angle or telephoto end is long, and the lens diameter and barrel diameter also increase. In addition, if a sufficient distance is not secured between the first and second units, the first and second units are likely to collide with each other, and the lens barrel cannot be retracted from the wide-angle or telephoto end.

### SUMMARY

A lens apparatus according to one aspect of the disclosure includes a first unit, a second unit, a cam barrel, and a guide barrel. The cam barrel has a first cam groove for moving the first unit in an optical axis direction and a second cam groove for moving the second unit in the optical axis direction. The guide barrel has a first guide groove for restricting the first unit from rotating around an optical axis and a second guide groove for restricting the second unit from rotating around the optical axis. The second unit has a base unit and a holder unit. The holder unit is disposed closer to the first unit than the base unit in the optical axis direction. As the lens apparatus transitions from an imaging state to a non-imaging state, due to an action of the cam barrel and the guide barrel, the first unit moves closer to the second unit, and the second unit moves closer to the first unit, so that the holder unit and the first unit contact with each other. An imaging system having the above lens apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are external perspective views of an imaging system in this embodiment.

FIG. 2 is a block diagram of the imaging system in this embodiment.

FIG. 3 is a sectional view of an interchangeable lens (at a wide-angle end) in this embodiment.

FIG. 4 is a sectional view of the interchangeable lens (at a telephoto end) in this embodiment.

FIG. 5 is a sectional view of the interchangeable lens (at a retracted end) in this embodiment.

FIG. 6 is an exploded perspective view of a second zoom unit in this embodiment.

FIGS. 7A to 7D are sectional views of the interchangeable lens illustrating a first zoom unit and the second zoom unit according to this embodiment.

FIGS. 8A, 8B, 8C, and 8D explain a cam barrel and a click mechanism in this embodiment.

FIGS. 9A and 9B explain the click mechanism in this embodiment.

### DETAILED DESCRIPTION

Referring now to the accompanying drawings, a detailed description will be given of embodiments according to the disclosure. Corresponding elements in respective figures will be designated by the same reference numerals. This embodiment uses an interchangeable lens as an example optical apparatus, but the present disclosure can be modified and changed in various ways within the scope of the present disclosure, such as a lens integrated type camera.

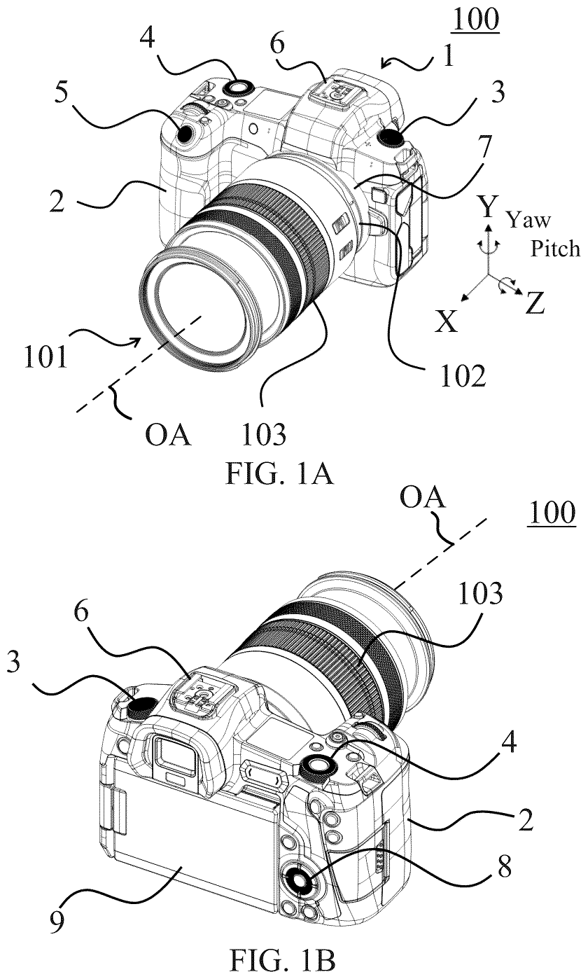

Referring now to FIGS. 1A and 1B, a description will be given of an imaging system 100 according to this embodiment. FIGS. 1A and 1B are external perspective views of the imaging system 100. More specifically, FIG. 1A illustrates a perspective view of the imaging system 100 viewed from the front side (object side), and FIG. 1B illustrates a perspective view of the imaging system 100 viewed from the rear side (image plane side). In this embodiment, as illustrated in FIG. 1A, an optical axis direction, which is a direction in which an optical axis OA of the imaging optical system housed in the interchangeable lens 101 extends (direction along the optical axis), is defined as an X-axis direction, and directions perpendicular to the optical axis direction are defined as a Z-axis direction (horizontal direction) and a Y-axis direction (vertical direction). The Z-axis direction and the Y-axis direction will be collectively referred to as a Z/Y-axis direction hereinafter. A rotating direction around the Z-axis is defined as a pitch direction, and a rotating direction around the Y-axis is defined as a yaw direction. The pitch direction and the yaw direction (collectively referred to as a pitch/yaw direction hereinafter) are rotating directions around two mutually orthogonal axes, the Z-axis and the Y-axis.

The imaging system 100 includes a camera body (digital camera, image pickup apparatus) 1, and an interchangeable lens (lens apparatus, lens barrel) 101 attachable to and detachable from the camera body 1. This embodiment is not limited to this example, and is appliable to an image pickup apparatus in which the camera body and the lens apparatus are integrated.

The camera body 1 includes a grip portion 2 on the left side when viewed from the front (right side when viewed from the back) that allows the user to hold the camera body 1 with his hand. A power operation portion 3 is disposed on the top surface of the camera body 1. In a case where the user turns on the power operation portion 3 when the camera body 1 is in a power-off state, electricity is started, the camera body 1 is powered on, a computer program such as processing of detecting an origin of the focus unit is executed, and the camera body 1 transitions to an imaging standby state. In a case where the user turns off the power operation portion 3 when the camera body 1 is in a power-on state, the camera body 1 is powered off.

The top surface of the camera body 1 includes a mode dial 4, a release button 5, and an accessory shoe 6. The user can switch between imaging modes by rotating the mode dial 4. The imaging modes include a manual still image capturing mode in which the user can arbitrarily set an imaging condition such as a shutter speed and an F-number (aperture value), an automatic still image capturing mode in which a proper exposure can be automatically set, and a moving image capturing mode for moving image capturing. The user can instruct an imaging preparation operation such as autofocus (AF) and auto-exposure (AE) control by half-pressing the release button 5, and can instruct imaging by fully pressing the release button 5. An accessory (camera accessory) such as an external flash or other illumination or light-emitting apparatus is detachably attached to the accessory shoe 6.

The interchangeable lens 101 includes a lens mount 102 that can be mechanically and electrically connected to a camera mount 7 provided on the camera body 1. The lens mount 102 and the camera mount 7, each of which has an annular shape, are made of a conductive metal material and can be attached and detached via an unillustrated bayonet coupling. As long as the camera system adopts a common mount shape, a combination of the interchangeable lens 101 and the camera body 1 is not limited.

The interchangeable lens 101 houses an imaging optical system that forms an object image by condensing light from the object. A zoom operation ring (operation member) 103 rotatable around the optical axis by user operation is provided on the outer circumference of the interchangeable lens 101. As the zoom operation ring 103 is rotated by the user, the zoom unit that constitutes the imaging optical system moves to a predetermined use position corresponding to an angle of the zoom operation ring 103 within a range from the wide-angle end to the telephoto end. Thus, the user is ready for imaging at a desired angle of view. As will be detailed later, in this disclosure, a retracted end that restricts imaging is provided at a position after the zoom operation ring 103 is rotated from the telephoto end to the wide-angle end. The retracted end is a position where the interchangeable lens 101 is most retracted.

As illustrated in FIG. 1B, a rear operation unit 8 and a display unit 9 are provided on the rear surface of the camera body 1. The rear operation unit 8 includes a plurality of buttons and dials to which various functions are assigned. In a case where the camera body 1 is powered on and the still or moving image capturing mode is set, the display unit 9 displays a through-image (live-view image) of an object image captured by an image sensor described later. The display unit 9 also displays an imaging parameter indicating an imaging condition such as a shutter speed and F-number, and the user can change a set value of the imaging parameter by operating the rear operation unit 8 while viewing the display. The rear operation unit 8 includes a playback button for instructing playback of a recorded captured image, and the captured image is played back and displayed on the display unit 9 in a case where the user operates the playback button. The display unit 9 may be of a touch panel type and have the same function as that of the rear operation unit 8.

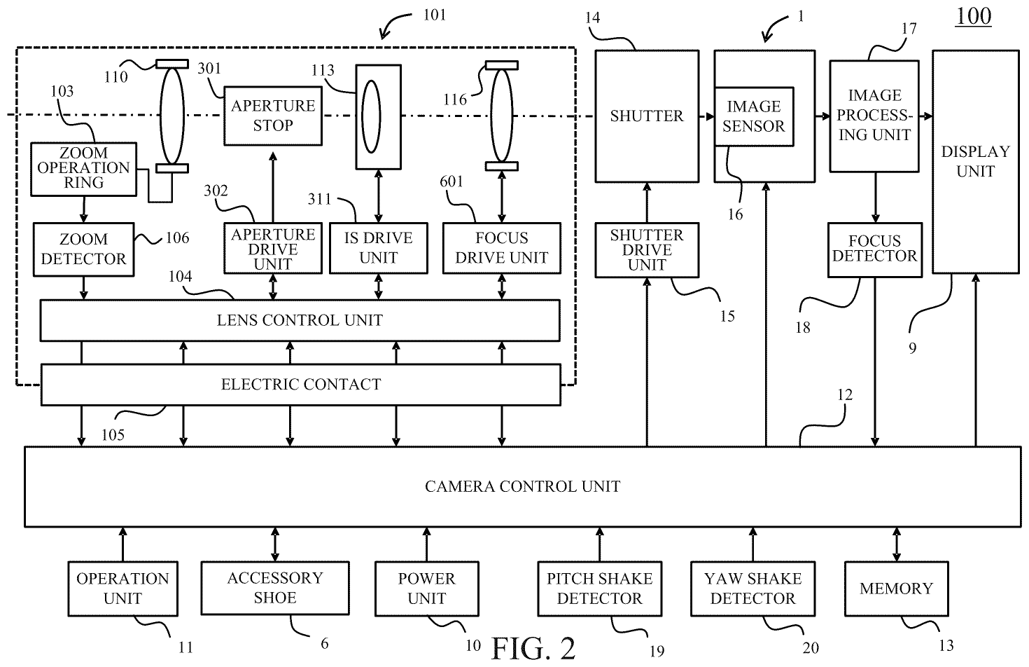

Referring now to FIG. 2, a description will be given of the electrical and optical configuration of the imaging system 100. FIG. 2 is a block diagram of the imaging system 100. The camera body 1 has a power supply unit 10 that supplies power to the camera body 1 and the interchangeable lens 101, the power operation portion 3, the mode dial 4, the release button 5, and an operation unit 11 including the rear operation unit 8 and a touch panel function of the display unit 9. In this embodiment, the camera body 1 and the interchangeable lens 101 as an entire system are controlled by a camera control unit 12 provided in the camera body 1 and a lens control unit 104 provided in the interchangeable lens 101 in cooperation with each other. Each of the camera control unit 12 and the lens control unit 104 has a built-in computer for controlling the camera body 1 and the interchangeable lens 101, respectively, and the entire system of the camera body 1 and the interchangeable lens 101 is controlled by their cooperative operations.

The camera control unit 12 loads and executes a computer program stored in a memory 13. At that time, the camera control unit 12 communicates various control signals, data, and the like with the lens control unit 104 via a communication terminal of an electrical contact 105 provided in the lens mount 102. The electrical contact 105 includes a power terminal that supplies power from the power supply unit 10 to the interchangeable lens 101.

The imaging optical system in the interchangeable lens 101 includes a zoom unit 110 that is connected to the zoom operation ring 103 and moves in the optical axis direction to change an angle of view, and an aperture unit (aperture stop unit) 301 that performs a light amount adjustment operation. The imaging optical system further includes a lens image-stabilizing (IS) unit 113 that includes a shift lens as an image-stabilizing element, and reduces image blur by moving (shifting) in the Z/Y axis directions perpendicular to the optical axis. The imaging optical system further includes a focus unit 116 that includes a focus lens that moves in the optical axis direction for focusing. The interchangeable lens 101 further includes an aperture drive unit 302 that drives the aperture unit 301, an image-stabilizing (IS) drive unit 311 that moves the lens IS unit 113, and a focus drive unit 601 that moves the focus unit 116.

The camera body 1 includes a shutter unit 14, a shutter drive unit 15, an image sensor 16, an image processing unit 17, and a camera control unit 12. The shutter unit 14 controls a light amount that is imaged by the image sensor optical system in the interchangeable lens 101 and exposed by the image sensor 16. The image sensor 16 photoelectrically converts an object image formed by the image sensor optical system and outputs an imaging signal. The image processing unit 17 performs various image processing for the imaging signal and then generates an image signal. The display unit 9 displays the image signal (through-image) output from the image processing unit 17, displays an imaging parameter, or plays back and displays a captured image recorded in the memory 13 or an unillustrated recording medium.

The camera control unit 12 controls the focus drive unit 601 according to an imaging preparation operation (such as half-pressing the release button 5) on the operation unit 11. For example, in a case where an AF operation is instructed, the focus detector 18 determines a focus state of the object image formed by the image sensor 16 based on the image signal generated by the image processing unit 17, generates a focus signal, and transmits it to the camera control unit 12. At the same time, the focus drive unit 601 transmits information regarding the current position of the focus unit 116 to the camera control unit 12. The camera control unit 12 compares the focus state of the object image with the current position of the focus unit 116, calculates a focus driving amount from a shift amount, and transmits it to the lens control unit 104. Then, the lens control unit 104 moves the focus unit 116 to a target position in the optical axis direction via the focus drive unit 601, and corrects the focus shift of the object image.

The focus drive unit 601 includes a focus motor that functions as an actuator, and a photo-interrupter that detects the origin position of the focus unit 116. Generally, a stepping motor, which is one type of actuator, is often used as the focus motor. A DC motor with an encoder, an ultrasonic motor, a servo motor, or the like may be used as the focus motor. The photo-interrupter directly receives light emitted from the light emitter at a light receiver, but instead, a photo-reflector that receives reflected light from a reflective surface, or a brush that contacts a conductive pattern and electrically detects a signal may be used as the detector.

The camera control unit 12 controls the driving of the aperture unit 301 and the shutter unit 14 via the aperture drive unit 302 and the shutter drive unit 15 according to a set value of the F-number or shutter speed received from the operation unit 11. For example, in a case where an AE control operation is instructed, the camera control unit 12 receives a luminance signal generated by the image processing unit 17 and performs a photometry calculation. Based on the result of the photometry calculation, the camera control unit 12 controls the aperture drive unit 302 according to the imaging instruction operation (such as the full pressing of the release button 5) in the operation unit 11. At the same time, the camera control unit 12 controls the drive of the shutter unit 14 via the shutter drive unit 15, and performs exposure processing by the image sensor 16.

The camera body 1 includes a pitch shake detector 19 and a yaw shake detector 20 as shake detectors capable of detecting image shake caused by the user's handheld shake or the like. Each of the pitch shake detector 19 and the yaw shake detector 20 uses an angular velocity sensor (vibration gyro) or an angular acceleration sensor to detect image shake in the pitch direction (rotating direction around the Z-axis) and the yaw direction (rotating direction around the Y-axis), and output a shake signal.

The camera control unit 12 calculates the shift position in the Y-axis direction of the lens IS unit 113 using the shake signal from the pitch shake detector 19. Similarly, the camera control unit 12 calculates the shift position in the Z-axis direction of the lens IS unit 113 using the shake signal from the yaw shake detector 20. Then, the camera control unit 12 moves the lens IS unit 113 to a target position in the Z/Y-axis direction via the IS drive unit 311 according to the calculated shift position in the pitch/yaw direction, thereby reducing image blur during exposure or during display of a through-image.

The interchangeable lens 101 includes the zoom operation ring 103 for changing an angle of view of the imaging optical system, and a zoom detector 106 for detecting the angle of the zoom operation ring 103. The zoom detector 106 detects the angle of the zoom operation ring 103 operated by the user as an absolute value, and includes, for example, a resistive linear potentiometer. Information regarding the angle of view detected by the zoom detector 106 is transmitted to the lens control unit 104 and is reflected in the various controls by the camera control unit 12 described above. On the other hand, part of the various information described above is recorded in the memory 13 or an unillustrated recording medium together with the captured image.

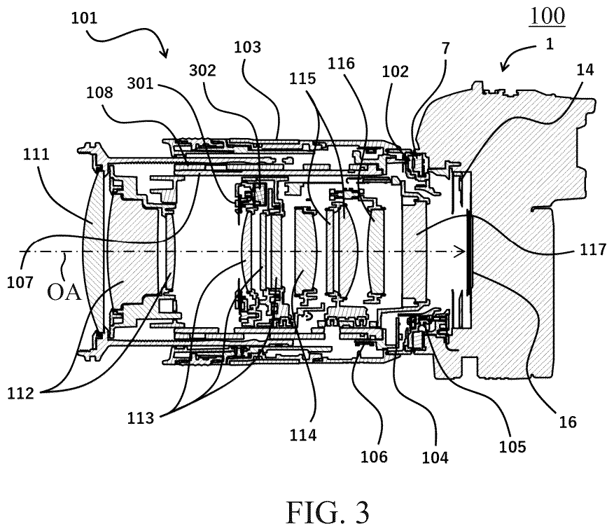

Referring now to FIGS. 3 to 5, a description will be given of the positional relationship among the main components of the interchangeable lens 101. FIGS. 3 to 5 are sectional views of an XY plane including the optical axis OA, and the center line illustrated here roughly coincides with the optical axis OA determined by the imaging optical system, and therefore hereinafter will be equivalent with the optical axis OA.

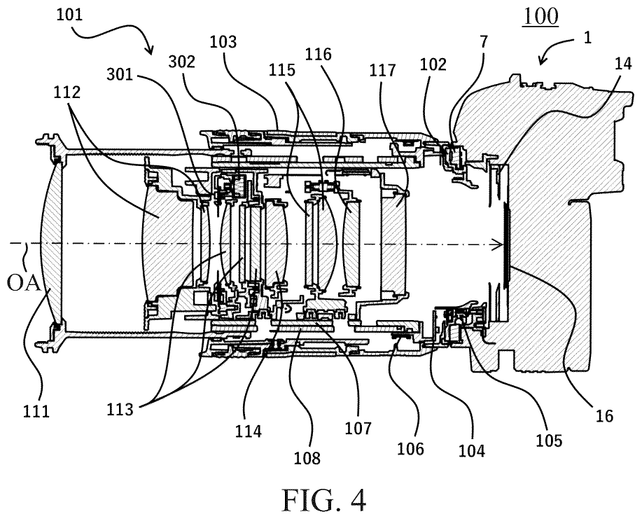

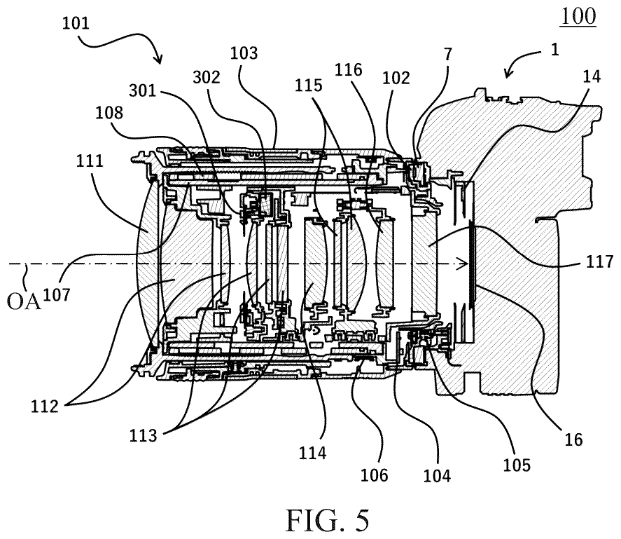

FIG. 3 illustrates the wide-angle end on the short focus side of the zoom, and FIG. 4 illustrates the telephoto end on the long focus side of the zoom. Both FIGS. 3 and 4 illustrate the imaging optical system of the interchangeable lens 101 in an imageable state. On the other hand, FIG. 5 illustrates the imaging optical system in the interchangeable lens 101 in a stored state (a retracted state) in a non-imaging state. FIG. 5 illustrates the retracted end that provides the shortest overall length in the optical axis direction.

The retracted end illustrated in FIG. 5 is provided beyond the wide-angle end in FIG. 3, and by rotating the zoom operation ring 103 in one direction, the zoom moves from the retracted end in FIG. 5 to the wide-angle end in FIG. 3, and from the wide-angle end in FIG. 3 to the telephoto end in FIG. 4. In this embodiment, a state in which imaging using the imaging optical system is possible is called an imaging state, and a state in which the imaging optical system is in the retracted position is called a retracted state. The imageable state means a state in which the functions of the imaging system 100 including the camera body 1 and the interchangeable lens 101 can always operate normally. Imaging restriction means that at least a part of the functions of the imaging system 100 including the camera body 1 and the interchangeable lens 101 do not operate normally. For example, in a case where the imaging optical system is located at the retracted position, an imaging act (such as pressing the shutter to image an object) is possible, but part or whole of the captured image may be blurred due to defocus or the like.

As illustrated in FIGS. 3 and 4, this embodiment uses an optical system with a seven-unit configuration as an example imaging optical system. The zoom unit 110 moves to a predetermined use position to image light from an object on the image sensor 16. The predetermined position at the wide-angle end and the predetermined use position at the telephoto end are different. The zoom unit 110 includes a first zoom unit 111, a second zoom unit 112, an aperture unit 301, a lens IS unit (third zoom unit) 113, a fourth zoom unit 114, a fifth zoom unit 115, a focus unit (sixth zoom unit) 116, and a seventh zoom unit 117. In this embodiment, the configuration of the imaging optical system is not limited, and for example, at least one of the lens IS unit 113 and the focus unit 116 may function as another zoom unit. Some lens units may not be movable and may be fixed.

In this embodiment, the first zoom unit 111 will be described as a first unit, and the second zoom unit will be described as a second unit. However, this embodiment is not limited to this example, and any two zoom units (or lens units) can be applied as the first unit and the second unit.

The linear guide barrel 107 is a fixed part (guide barrel) fixed to the lens mount 102 via a fixed barrel 109. The fixed barrel 109 holds the zoom operation ring 103 rotatably around the optical axis. Unillustrated bayonet claws are arranged at regular intervals on the outer circumferential surface of the linear guide barrel 107. On the other hand, an unillustrated circumferential groove is provided in the inner circumferential surface of the cam barrel 108. The cam barrel 108 is connected to the zoom operation ring 103. In a case where the user rotates the zoom operation ring 103, the bayonet claws are engaged with the circumferential grooves, the movement of the cam barrel 108 in the optical axis direction is restricted, and the cam barrel 108 rotates around the optical axis OA.

As will be detailed later, the linear guide barrel 107 has linear guide grooves formed at regular intervals that restrict the movement of the zoom unit 110 in the rotational direction and guide linear movement in the optical axis direction. The cam barrel 108 has cam grooves, each of which has a locus with a different angle in the rotating direction, and these cam grooves are formed at regular intervals in correspondence with the zoom unit 110. On the other hand, the zoom unit 110 includes a plurality of rollers, each of which is engaged with a corresponding linear guide groove and cam groove. In a case where the user rotates the zoom operation ring 103, the cam barrel 108 rotates, and the rollers move the zoom unit 110 (back and forth) in the optical axis direction while restricting movement in the rotating direction due to the engagements with the linear guide grooves and the cam grooves.

The interchangeable lens 101 according to this embodiment has a retractable mechanism, which will be detailed later. The retractable mechanism allows the zoom unit 110 to be retracted toward the rear side (image plane side) in the non-imaging state. This configuration can reduce the overall length of the interchangeable lens 101, and improve the portability of the interchangeable lens 101 and the camera body 1.

At the wide-angle end illustrated in FIG. 3, a distance between the second zoom unit 112 and the lens IS unit (third zoom unit) 113 is wide. At the telephoto end illustrated in FIG. 4, a distance between the first zoom unit 111 and the second zoom unit 112 is wide. The retractable mechanism narrows each of these distances, moves them to a storage position close to each other, and reduces the overall length in the optical axis direction. As illustrated in FIG. 5, at the retracted end in the non-imaging state, the zoom unit 110 move to a storage position close to each other. From this state, for example, in a case where the user rotates the zoom operation ring 103 to the wide-angle end, the zoom unit 110 extends to the front side (object side) and moves to a predetermined use position. Thereby, an imageable state is achieved as illustrated in FIG. 3.

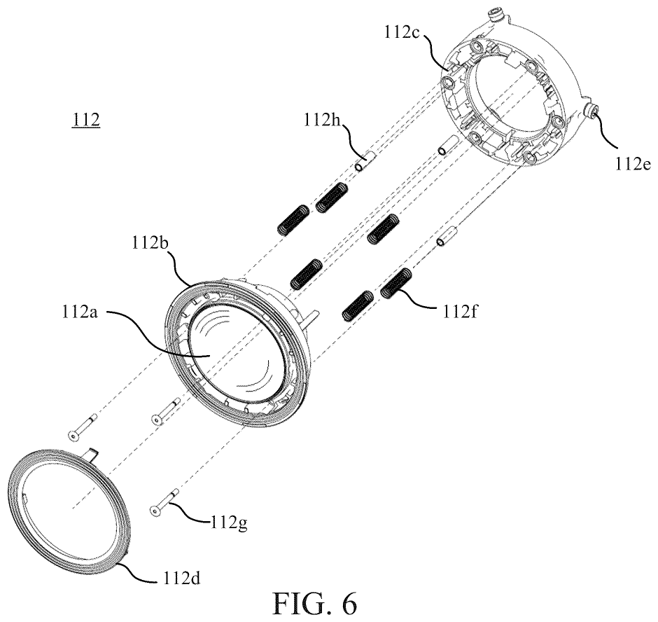

Referring now to FIG. 6, a detailed description will be given of the configuration of the second zoom unit 112. FIG. 6 is an exploded perspective view of the second zoom unit 112. A holder unit 112b holds a lens (lens unit) 112a inside of it and holds a cover 112d on the first zoom unit 111 side. In this embodiment, the cover 112d is a molded part, but depending on the optical design, it may be, for example, a sheet part.

A base unit 112c holds a plurality of rollers (followers) 112e at regular intervals on its outer circumference, and holds a plurality of guide shafts 112h on the holder unit 112b side. The guide shafts 112h have a cylindrical shape and are press-fitted into the base unit 112c. The holder unit 112b is located closer to the first zoom unit 111 than the base unit 112c in the optical axis direction. A plurality of biasing members (first biasing members) 112f are provided between the holder unit 112b and the base unit 112c. In this embodiment, the biasing members 112f are compression coil springs, but the type of spring is not limited as long as the biasing members 112f can bias the holder unit 112b and the base unit 112c in directions separating them from each other, and may be an elastic member other than the spring. A plurality of guide holes (not illustrated) are formed in the holder unit 112b. The holder unit 112b is positioned and held by the base unit 112c by fitting the guide shaft 112h in a number of guide holes.

The second zoom unit 112 further includes screws 112g coaxial with the guide shafts 112h. The screws 112g are fixed to the base unit 112c via the guide shafts 112h from the cover 112d side of the holder unit 112b. Thereby, the holder unit 112b is positioned relative to the base unit 112c by the guide shafts 112h, and is held so that they are spaced from each other by the biasing members 112f. As a result, the second zoom unit 112 is formed.

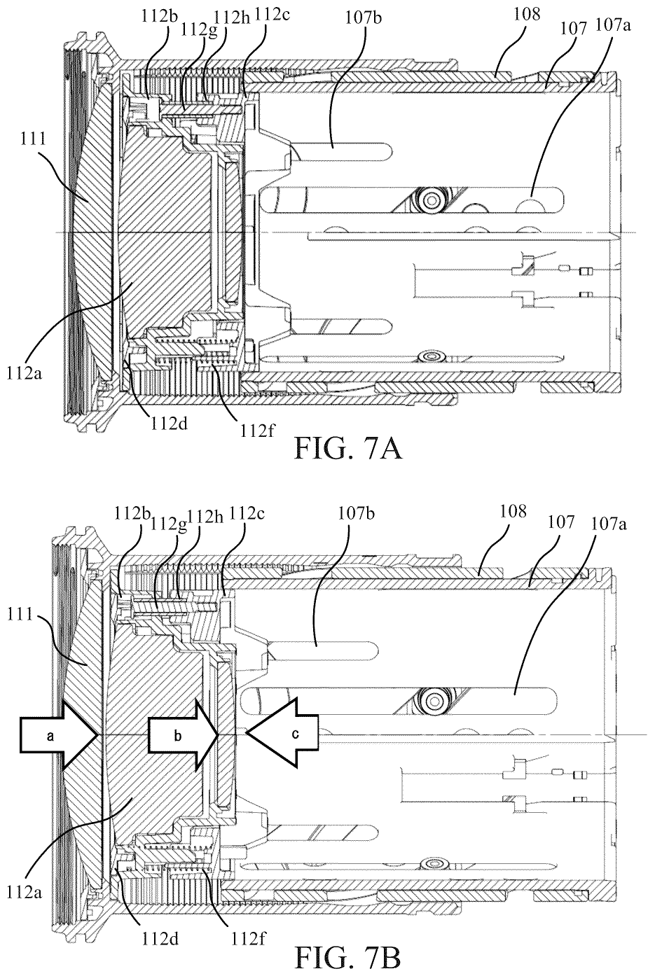

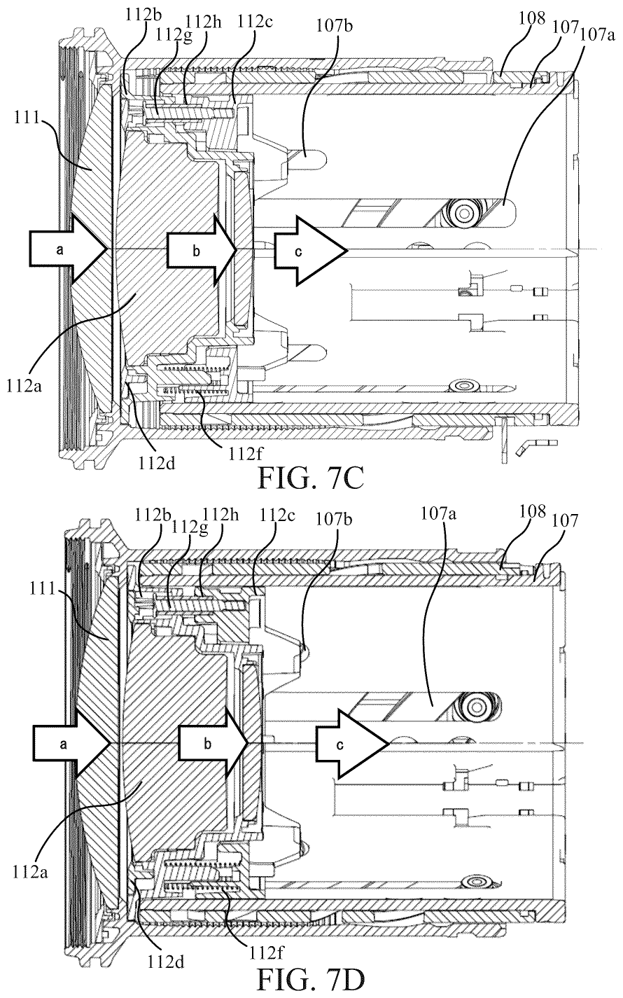

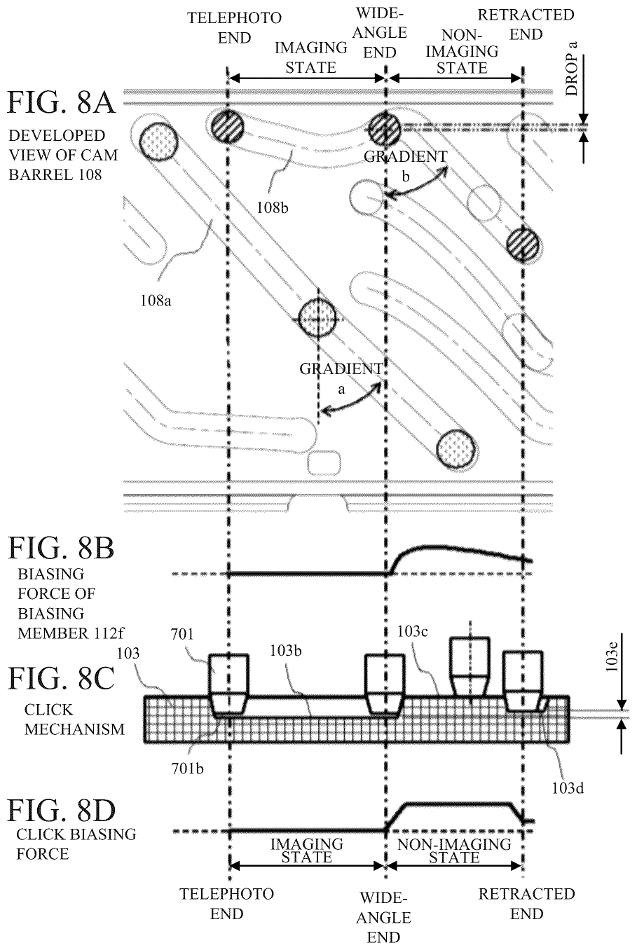

Referring now to FIGS. 7A to 8D, a description will be given of a relationship between the first zoom unit 111 and the second zoom unit 112 in a case where the interchangeable lens (lens barrel) 101 transitions from an imaging state to a non-imaging state and then a retracted state. FIGS. 7A, 7B, 7C, and 7D are sectional views of the interchangeable lens 101 illustrating the first zoom unit 111 and the second zoom unit 112. FIG. 7A illustrates a section at one end in the imaging state. FIG. 7B illustrates a section in a case where the interchangeable lens transitions from the imaging state to the non-imaging state. FIG. 7C illustrates a section in a case where the interchangeable lens transitions from the non-imaging state to the retracted end. FIG. 7D illustrates a section at the retracted end. FIGS. 8A, 8B, 8C, and 8D explain the cam barrel 108 and the click mechanism 700. FIG. 8A is a development view of the cam barrel 108 based on the second zoom unit 112. FIG. 8B explains the biasing force by the biasing member 112f. FIG. 8C is a schematic sectional view of the click mechanism 700 provided in the interchangeable lens 101. FIG. 8D explains the click force by the click mechanism 700.

The rotation around the optical axis of the first zoom unit 111 is restricted by a plurality of linear grooves (first guide grooves) 107a provided in the linear guide barrel 107, and the first zoom unit 111 is held movably (back and forth) in the optical axis direction by a plurality of cam grooves (first cam grooves) 108a provided in the cam barrel 108. Similarly, the rotation of the second zoom unit 112 around the optical axis is restricted by a plurality of linear grooves (second guide grooves) 107b provided in the linear guide barrel 107, and the second zoom unit 112 is held movably (back and forth) in the optical axis direction by a plurality of cam grooves (second cam grooves) 108b provided in the cam barrel 108.

As illustrated in FIG. 7A, in a case where the interchangeable lens 101 is located at one end in the imaging state, the first zoom unit 111 and the second zoom unit 112 are closest to each other. In this embodiment, one end of the interchangeable lens 101 is the wide-angle end, but depending on the optical design, etc., it may be at the telephoto end. In a case where the interchangeable lens 101 is in the imaging state, the base unit 112c and the holder unit 112b constituting the second zoom unit 112 are biased in directions separating them from each other by the biasing member 112f as described above.

As illustrated in FIG. 7B, in a case where the interchangeable lens 101 transitions from the one end in the imaging state to the non-imaging state, the first zoom unit 111 moves toward the second zoom unit 112 along the cam grooves 108a in the cam barrel 108 due to the action of the linear guide barrel 107 and the cam barrel 108 (arrow a). At this time, the base unit 112c moves toward the first zoom unit 111 along the cam grooves 108b due to the action of the linear guide barrel 107 and the cam barrel 108 (arrow c), and the holder unit 112b comes into contact with the first zoom unit 111.

As described above, the base unit 112c and the holder unit 112b are biased in directions separating them from each other by the biasing members 112f. Thus, the holder unit 112b comes into contact with the first zoom unit 111 and moves toward the base unit 112c along the cam grooves 108a (arrow b). Thereby, as illustrated in FIG. 7B, the biasing members 112f are compressed, the holder unit 112b moves toward the base unit 112c together with the first zoom unit 111, and the first zoom unit 111 and the second zoom unit 112 move to the closest position.

As illustrated in FIG. 7C, in a case where the interchangeable lens 101 moves from the state illustrated in FIG. 7B to the retracted end, the first zoom unit 111 moves further toward the second zoom unit 112 along the loci of the cam grooves 108a due to the action of the linear guide barrel 107 and the cam barrel 108 (arrow a). In a case where the first zoom unit 111 and the second zoom unit 112 move further toward the retracted end from the state where they are closest to each other (the state in FIG. 7B), the base unit 112c moves toward the retracted end along the cam grooves 108b due to the action of the linear guide barrel 107 and the cam barrel 108 (arrow c). As described above, since the first zoom unit 111 and the holder unit 112b contact each other, the holder unit 112b moves toward the base unit 112c along the cam grooves 108a (arrow b).

As illustrated in FIG. 7D, in a case where the interchangeable lens 101 has completed the transition to the retracted state, the first zoom unit 111 moves toward the second zoom unit 112 along the loci of the cam grooves 108a (arrow a) due to the action of the linear guide barrel 107 and the cam barrel 108, and moves to the retracted end. The base unit 112c moves to the retracted end along the cam grooves 108b (arrow c) due to the action of the linear guide barrel 107 and the cam barrel 108. As described above, since the first zoom unit 111 and the holder unit 112b contact each other, the holder unit 112b moves toward the base unit 112c along the cam grooves 108a (arrow b). Through the above operations, the interchangeable lens 101 transitions from the imaging state to the non-imaging state and completes the transition to the retracted state (retracted end).

In a case where a gradient a of each cam groove 108a and a gradient b of each cam groove 108b are considered in the cam barrel 108 in FIG. 8A, a relationship holds the gradient a>the gradient b. Thus, the first zoom unit 111 and the second zoom unit 112 gradually separate from each other as they transition to the retracted state. As described with reference to FIG. 7B, in a case where the interchangeable lens 101 transitions from the imaging state to the non-imaging state, the first zoom unit 111 and the second zoom unit 112 are closest to each other.

As described above, the biasing force by each biasing member 112f generated between the first zoom unit 111 and the second zoom unit 112 is highest when the imaging state transitions to the non-imaging state, as illustrated in FIG. 8B, and then gradually decreases. That is, the biasing force by each biasing member 112f increases as the holder unit 112b in contact with the first zoom unit 111 moves toward the first position together with the first zoom unit 111 so as to approach the base unit 112c, and decreases as it moves from the first position toward the retracted end. Due to this fact, the first zoom unit 111 is prevented from unexpectedly extending even if an external force is applied when the interchangeable lens 101 is in the retracted state.

Now consider the length of the cam barrel 108 in the optical axis direction. Then, in this embodiment, during the transition from the state in FIG. 7A to the state in FIG. 7B, the holder unit 112b moves toward the base unit 112c by a drop a in FIG. 8A.

In the conventional lens barrel, in order to transition from one end in the imaging state to the non-imaging state, a distance between the first zoom unit and the second zoom unit needs to be equal to or longer than a distance equivalent to the drop a in this embodiment. Therefore, the overall length of the cam barrel and the overall length of the lens barrel increase, and securing a sufficient distance between the zoom units is likely to increase the lens diameter and the lens barrel diameter depending on the optical design. In a case where the distance between the zoom units is not sufficiently secured, the first zoom unit and the second zoom unit may collide, and thus the transition from one end in the imaging state to the non-imaging state is not acquired.

On the other hand, in this embodiment, in a case where the interchangeable lens 101 transitions from the imaging state to the non-imaging state, the base unit 112c moves toward the first zoom unit 111, and the first zoom unit 111 moves toward the second zoom unit 112. The holder unit 112b is configured to contact the first zoom unit 111 and move toward the base unit 112c together with the first zoom unit 111. Thereby, this embodiment can reduce the overall length of the cam barrel, the overall length of the lens barrel, and the overall lens length in the retracted state in comparison with the prior art, and achieve a reduced lens diameter and a reduced lens barrel diameter.

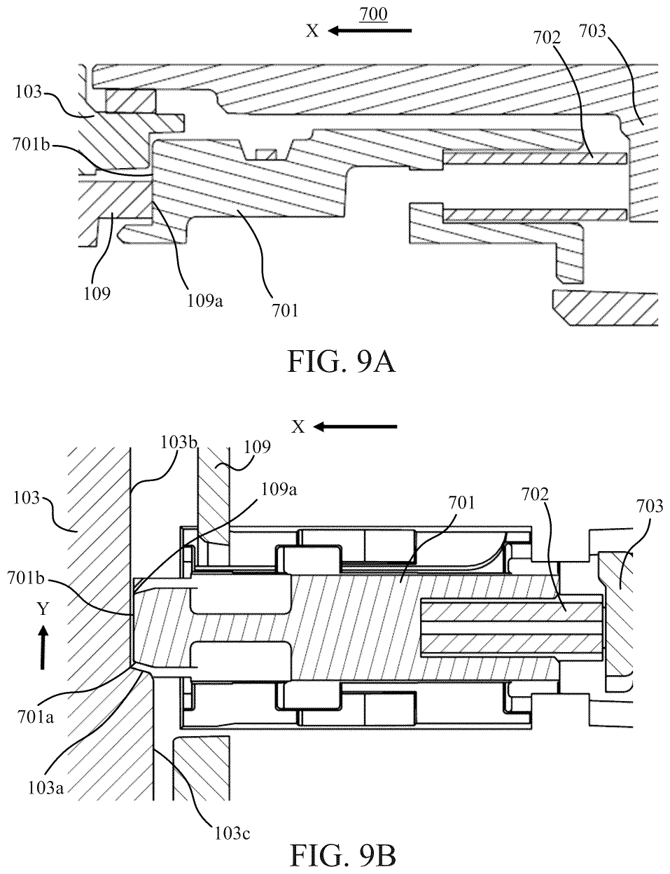

Referring now to FIGS. 9A and 9B, a description will be given of a click mechanism 700 for providing a clicking feeling (moderation feeling) to the operation of the zoom operation ring 103. FIGS. 9A and 9B explain the click mechanism 700. FIG. 9A is a side sectional view of the click mechanism 700, and FIG. 9B is a bottom sectional view of the click mechanism 700 as viewed from the center of the optical axis. FIGS. 9A and 9B illustrate the arrangement of the click mechanism 700 near the imaging end in the imaging area described later.

In FIGS. 9A and 9B, the horizontal axis represents a phase (rotational position, position in a direction around the optical axis) of the zoom operation ring 103, and FIGS. 9A and 9B schematically illustrate the relative positional relationship among the components in the zoom, expressing that a pin member 701 moves relative to the zoom operation ring 103. However, it is the zoom operation ring 103 that actually rotates, and the phase (position in the direction around the optical axis) of the pin member 701 is fixed by the fixed barrel 109.

The click mechanism 700 is a mechanism for locking the rotation of the zoom operation ring 103, and is realized mainly by the fixed barrel 109, the pin member 701, a part of the zoom operation ring 103 (tapered portion 103a), an exterior ring 703, and a biasing member (second biasing member) 702. The pin member 701 is an engagement member held by the fixed barrel 109 linearly movably in the optical axis direction. The pin member 701 includes a tip portion 701b, and a side surface adjacent to the tip portion 701b is a tapered portion 701a having a tapered shape.

The biasing member (second biasing member) 702 is held by a sleeve shape of the pin member 701, receives a reaction force from the exterior ring 703, and biases the pin member 701 toward the fixed barrel 109 and the zoom operation ring 103 (X direction). The biasing member 702 is, for example, a compression coil spring, and is disposed on the opposite side of the tip portion 701b of the pin member 701, but the biasing method is not limited as long as it can bias the pin member 701 in the X direction.

The inner circumference surface of the zoom operation ring 103 has a protruding tapered portion 103a, a first flat portion (first concave portion) 103b corresponding to the imaging state, a second flat portion (convex portion) 103c corresponding to the retracted state, and a third flat portion (second concave portion) 103d corresponding to the retracted position (retracted end). As illustrated in FIG. 9A, in a case where the interchangeable lens 101 is in the imaging state, the tip portion 701b of the pin member 701 contacts a contact portion 109a provided on the fixed barrel 109. Thus, the biasing force of the biasing member 702 does not act on the zoom operation ring 103.

In a case where the zoom operation ring 103 is rotated in the Y direction, the tapered portion 103a of the zoom operation ring 103 and the tapered portion 701a of the pin member 701 contact and are engage with each other, and the rotation of the zoom operation ring 103 is locked. In a case where the zoom operation ring 103 is further rotated in the Y direction, the pin member 701 moves in the-X direction along the tapered portion 103a, and the tip portion 701b of the pin member 701 climbs over (rides over) the tapered portion 103a. At this time, the biasing force of the biasing member 702 acts on the zoom operation ring 103, becomes a load on the rotation operation, and generates a click feeling.

In the click mechanism 700, by changing the angles of the tapered portions 103a and 701a, and the biasing force of the biasing member 702, a click feeling suitable for the rotation operation of the zoom operation ring 103 can be arbitrarily set. This clicking feeling allows the user to recognize a boundary between the phases of the zoom operation ring 103 (a boundary between the imaging state and the non-imaging state) etc. from the operational feeling.

In this embodiment, the click mechanism 700 locks the rotation of the zoom operation ring 103 in the imaging state near the phase where the holder unit 112b contacts the first zoom unit 111. The rotation phase (position in the direction around the optical axis) where the rotation of the zoom operation ring 103 is locked by the click mechanism 700 may correspond to the boundary between the imaging state and the non-imaging state. The boundary may correspond to one end (wide-angle end or telephoto end) in the imaging state. The torque required when the zoom operation ring 103 rotates further from the rotation phase where the rotation of the zoom operation ring 103 is locked by the click mechanism 700 may be smaller than the biasing force of the biasing member 112f.

Referring now to FIGS. 8A to 8D, a description will be given of a relationship among the biasing force of the biasing member 112f and the click timing and click biasing force of the click mechanism 700. As illustrated in FIGS. 8A and 8D, in a case where the interchangeable lens 101 is in the imaging state, the base unit 112c and the holder unit 112b are biased in directions separating them from each other by the biasing members 112f. Thus, as illustrated in FIG. 8C, the tip portion 701b of the pin member 701 does not contact the first flat portion 103b of the zoom operation ring 103. Thus, the biasing forces of the biasing members 112f and 702 do not act on the zoom operation ring 103.

Next, in the transition from the imaging state to the non-imaging state, as illustrated in FIGS. 8A and 8B, the biasing member 112f is compressed by the drop a, so the biasing force of the biasing member 112f increases. At this time, the biasing force of the biasing member 702 acts on the zoom operation ring 103, creates a load on the rotation operation, and generates a clicking feeling.

Now consider that the timings of the biasing force of the biasing member 112f and the click biasing force of the click mechanism 700. Then, both increase in the transition from the imaging state to the non-imaging state. Thus, the timing in a case where the base unit 112c and the holder unit 112b constituting the second zoom unit 112 approach each other and the timing in a case where the tip portion 701b of the pin member 701 climbs over (rides over) the tapered portion 103a and generates a click biasing force are simultaneous.

As described above, in this embodiment, the tip portion 701b of the pin member 701 does not contact the zoom operation ring 103 in the imaging state, and contacts the zoom operation ring 103 in the non-imaging state due to the biasing member 702. The rotational torque of the zoom operation ring 103 may be larger in the non-imaging state than in the imaging state. The biasing force of the biasing member 702 may increase as the pin member 701 rides over the tapered portion 103a, and reduces at the retracted end. Thereby, the interchangeable lens 101 can be transitioned from the imaging state to the retracted state while good rotation operation of the zoom operation ring 103 is maintained.

In this embodiment, the first zoom unit (first unit) 111 is disposed on the object side of the second zoom unit (second unit) 112 having the base unit 112c and the holder unit 112b, but this embodiment is not limited to this example. The lens unit in the first unit may be disposed on the image side of the lens unit in the second unit.

In this embodiment, in the transition from the imaging state to the non-imaging state, the action of the cam barrel and the guide barrel causes the first unit to move closer to the second unit, and the second unit to move closer to the first unit, and thereby the holder unit and the first unit contact each other. This embodiment can provide a lens apparatus and imaging system that has a reduced size and overall length.

While the disclosure has described example embodiments, it is to be understood that some embodiments are not limited to the disclosed embodiments. The scope of the following claims is to be accorded the broadest interpretation so as to encompass all such modifications and equivalent structures and functions.

This embodiment can provide a lens apparatus that has a reduced size and overall length.

This application claims priority to Japanese Patent Application No. 2023-204314, which was filed on Dec. 4, 2023, and which is hereby incorporated by reference herein in its entirety.

What is claimed is:

1. A lens apparatus comprising:
a first unit;
a second unit;
a cam barrel; and
a guide barrel,
wherein the cam barrel has a first cam groove for moving the first unit in an optical axis direction and a second cam groove for moving the second unit in the optical axis direction,
wherein the guide barrel has a first guide groove for restricting the first unit from rotating around an optical axis and a second guide groove for restricting the second unit from rotating around the optical axis,
wherein the second unit has a base unit and a holder unit,
wherein the holder unit is disposed closer to the first unit than the base unit in the optical axis direction, and
wherein as the lens apparatus transitions from an imaging state to a non-imaging state, due to an action of the cam barrel and the guide barrel, the first unit moves closer to the second unit, and the second unit moves closer to the first unit, so that the holder unit and the first unit contact with each other.

2. The lens apparatus according to claim 1, wherein when the lens apparatus transitions from the imaging state to the non-imaging state, the holder unit moves together with the first unit to approach the base unit.

3. The lens apparatus according to claim 1, wherein the holder unit holds a lens, and
wherein the base unit holds followers.

4. The lens apparatus according to claim 1, wherein the first unit and the second unit are closest to each other at one end in the imaging state.

5. The lens apparatus according to claim 4, wherein the one end is a wide-angle end or a telephoto end.

6. The lens apparatus according to claim 1, wherein the second unit includes a first biasing member, and
wherein the base unit and the holder unit are biased by the first biasing member in directions separating the base unit and the holder unit from each other.

7. The lens apparatus according to claim 6, wherein a biasing force of the first biasing member increases when the holder unit in contact with the first unit moves toward a first position together with the first unit so that the holder unit approaches the base unit, and the biasing force reduces as the holder unit moves from the first position toward a retracted end.

8. The lens apparatus according to claim 1, wherein the second unit includes a guide shaft, and
wherein the holder unit moves in the optical axis direction while being guided by the guide shaft.

9. The lens apparatus according to claim 1, further comprising:
an operation member rotatable around the optical axis;
a click mechanism configured to lock a rotation of the operation member,
wherein the click mechanism locks the rotation of the operation member near a phase where the holder unit contacts the first unit in the imaging state.

10. The lens apparatus according to claim 9, wherein a rotation phase where the rotation of the operation member is locked by the click mechanism corresponds to a boundary between the imaging state and the non-imaging state.

11. The lens apparatus according to claim 10, wherein the boundary corresponds to one end in the imaging state.

12. The lens apparatus according to claim 9, wherein the second unit includes a first biasing member, and
wherein a torque required for the operation member to rotate further from a rotation phase where the rotation of the operation member is locked by the click mechanism is smaller than a biasing force of the first biasing member.

13. The lens apparatus according to claim 9, wherein the click mechanism has a concave portion at a position corresponding to a retracted end of the operation member.

14. The lens apparatus according to claim 9, wherein the click mechanism includes:
a fixed barrel that holds the operation member rotatably around the optical axis;
an engagement member movably held on the fixed barrel; and
a second biasing member that biases the engagement member toward the operation member,
wherein the operation member has a tapered portion, and
wherein the engagement member rides up the tapered portion and thereby provides the operation member with a click feeling.

15. The lens apparatus according to claim 14, wherein a tip portion of the engagement member does not contact the operation member in the imaging state, and contacts the operation member in the non-imaging state due to biasing by the second biasing member.

16. The lens apparatus according to claim 14, wherein a biasing force of the second biasing member increases when the engagement member rides up the tapered portion, and decreases at a retracted end.

17. The lens apparatus according to claim 9, wherein a rotation torque of the operation member is larger in the non-imaging state than in the imaging state.

18. The lens apparatus according to claim 9, wherein the cam barrel is connected to the operation member.

19. The lens apparatus according to claim 14, wherein the guide barrel is fixed to a lens mount via the fixed barrel.

20. The lens apparatus according to claim 1, wherein the first unit is disposed on an object side of the second unit.

21. An imaging system comprises:
a lens apparatus; and
an image pickup apparatus,
wherein the lens apparatus includes:
a first unit;
a second unit;
a cam barrel; and
a guide barrel,
wherein the cam barrel has a first cam groove for moving the first unit in an optical axis direction and a second cam groove for moving the second unit in the optical axis direction,
wherein the guide barrel has a first guide groove for restricting the first unit from rotating around an optical axis and a second guide groove for restricting the second unit from rotating around the optical axis,
wherein the second unit has a base unit and a holder unit,
wherein the holder unit is disposed closer to the first unit than the base unit in the optical axis direction, and
wherein as the lens apparatus transitions from an imaging state to a non-imaging state, due to an action of the cam barrel and the guide barrel, the first unit moves closer to the second unit, and the second unit moves closer to the first unit, so that the holder unit and the first unit contact with each other.
